(19) United States
(12) Patent Application Publication
(10) Pub. No.: US 2008/0216931 A1
(43) Pub. Date: Sep. 11, 2008

(54) Device for Tire Inflation

(76) Inventor: Amiram Shoshana, Bat-Yam (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/066,722

(22) PCT Filed: Sep. 14, 2006
(86) PCT No.: PCT/IL06/01086

§ 371 Date: Mar. 13, 2008

Related U.S. Application Data
(60) Provisional application No. 60/717,216, filed on Sep. 15, 2005.

(51) Int. Cl. B60C 29/06

(52) U.S. Cl. 152/415

(57) ABSTRACT

A device for inflating a deflated vehicle tire which comprises a tube, a first adapter and a second adapter disposed at each end of the tube, wherein the adapters are suitable for connecting to a valve of a vehicle tire, facilitating air flow, and an air-flow indicator which indicates existence of air-flow within the tube.

### FIELD OF THE INVENTION

The present invention relates to a device for tire inflation and, in particular, but not limited to, a device for inflating a deflated vehicle tire with air from an inflated vehicle tire.

### BACKGROUND OF THE INVENTION

In most current types of vehicle tires, when the tire is punctured, for example by a nail, slow leaking of air occurs, causing a depletion of air pressure in the tire. As long as the pressure has not dropped below a certain minimum, one can drive to the nearest gas station or garage to fix the puncture or re-inflate the tire to obtain the necessary pressure. If the air pressure in the tire is insufficient to drive safely or at all, the leaky tire is usually replaced with a spare tire that is intact. This action is time consuming, requires effort, and dirties the changer's hands and clothes. In addition, some drivers may not be capable (at all, for different reasons, or in particular occasions) to accomplish such technically and physically demanding task. Obviously, there is a need for other solutions, than replacing the leaky tire with a spare one, when there is not any spare tire in hand.

It is highly advantageous for the user of a vehicle to have a system that enables inflating the tire with insufficient air pressure, by using another tire, such as the spare tire, one or more of the other vehicle's tires, or from tires of another vehicle, which have higher air pressure. Such a system would enable faster and easier tire inflation.

In addition, inflating a tire from its corresponding tire (that is inflating a frontal tire using the opposite frontal tire or inflating a back tire using the opposite back tire etc.) would keep the tires in balance, and therefore the vehicle safer for use.

U.S. Pat. No. 2,663,348 (Farris et al) discloses a device for inflating an under-inflated tire of a vehicle with air from a spare vehicle tire which comprises an air hose, a clip of air chuck on one end of the hose, having means for fixing it to the valve stem of the spare tire, another air chuck at the other end of the hose for introducing air into the under inflated tire. Thus, the surplus air in the spare tier may be introduced into the under inflated tier. For convenience in use the hose may be provided with a manually operated air valve and a pressure gauge.

JP 55094805 (Nubuyuki) discloses a hose for inflating a punctured tire whose purpose is to fill a punctured tire with air easily and to run a considerable distance as it is by connecting an air introducing metal fitting, which is mounted on one end of the hose, to the air feed port of the spare tire and another metal fitting, which is attached to the other end of the hose, to the air feed port of the punctured tire so the high pressure air in the spare tire is fed to the punctured tire through the hose.

An important factor, which should be taken into account, is the prevention of loss of air from both of the tires—the inflated tire and especially the deflated tire—during the operation of inflation. As the tires cannot be connected to or disconnected from the inflation device simultaneously by only one person, during that connecting or disconnecting process, some air might escape from the tires. In addition, as the common user does not necessarily possess technical abilities, he might connect the device wrongly and in a way that would cause air to escape from the tires.

A common solution for preventing escape of air during the inflation operation is using valves in the inflation device, in order to regulate the flow of air, and such as non-return valves, which enable fluid flow in only one direction.

U.S. Pat. No. 3,712,336 (Bell, Jr.) discloses an air transfer line comprising a hose with a standard automobile tire valve in each end which is used to transfer air from an inflated tire to a flat tire. The standard valve in each end of the hose prevents loss of the air and also depresses the stem of each tire valve. The standard valve comprises a rubber tube soft at each end to flow under air pressure, and which is confined by a layer of non-expandable fabric. The objective of this patent is to provide an efficient means for transferring air from one tire to another, which is extremely economical in construction and practically fool proof in the prevention of the loss of air.

U.S. Pat. No. 4,852,624 discloses a tire inflation device for emergencies which includes a flexible hose, a supply chuck that is temporarily securable to inflated tire by means of a spring loaded retaining clip and having a pressure gauge on the inflation chuck at the other end of the tube, which comprises a movable check valve element. An extension projects from the inflation chuck for connecting the inflation chuck to recessed valve stems. It should be noted that the inflation chuck should be manually held on the tire stem of the flat tire during the whole inflation operation.

The objective of the present invention is to prevent loss of air during the operation of tire inflation and to provide a device, which is easy to use and user friendly. In addition, it is an objective of the present invention to provide a simple, portable, safe, and economical device for tire inflation.

### SUMMARY OF THE INVENTION

There is thus provided, in accordance with some preferred embodiments of the present invention, a device for inflating a deflated vehicle tire comprising:

a tube;

a first adapter and a second adapter disposed at each end of the tube, wherein the adapters are suitable for connecting to a valve of a vehicle tire, facilitating air flow;

and an air-flow indicator which indicates existence of air-flow within the tube.

Furthermore, in accordance with some preferred embodiments of the present invention, the air-flow indicator comprises acoustic air-flow indicator.

Furthermore, in accordance with some preferred embodiments of the present invention, the acoustic air-flow indicator comprises a whistle.

Furthermore, in accordance with some preferred embodiments of the present invention, the air-flow indicator comprises a visual air-flow indicator.

Furthermore, in accordance with some preferred embodiments of the present invention, at least a portion of the tube of said device is transparent.

Furthermore, in accordance with some preferred embodiments of the present invention, the visual air-flow indicator of said device comprises a vane located within said at least portion of the tube that is transparent.

Furthermore, in accordance with some preferred embodiments of the present invention, the visual air-flow indicator of said device comprises an orb located within said at least a portion of the tube that is transparent, the orb dimensions allowing the orb to move freely inside the transparent portion of the tube, and a first and second limiters located on either sides of the orb, limiting the motion of the orb within a predetermined distance within the tube and allowing passage of air.

Furthermore, in accordance with some preferred embodiments of the present invention, the orb is made of a solid material.

Furthermore, in accordance with some preferred embodiments of the present invention, at least one of the limiters comprises a tubular member having internal passage smaller than the dimensions of the orb presenting an inclined rim towards the orb, causing the orb to be held sideways against an inside wall of the tube when air flows in the direction of said at least one limiter.

Furthermore, in accordance with some preferred embodiments of the present invention, at least one of the adapters is integrated with one of the limiters.

Furthermore, in accordance with some preferred embodiments of the present invention, the device comprising a non-return valve.

Furthermore, in accordance with some preferred embodiments of the present invention, the non-return valve is integrated with the air-flow indicator.

Furthermore, in accordance with some preferred embodiments of the present invention, the non-return valve comprises a hollow tubular member with a passage having an opening that is smaller than the dimensions of the orb, whereby when the orb is pressed against the hollow tubular member the orb blocks the opening preventing air from flowing through the tube.

Furthermore, in accordance with some preferred embodiments of the present invention, the non-return valve is integrated with one of the limiters.

Furthermore, in accordance with some preferred embodiments of the present invention, the device provided with at least one indication on proper connection of the device.

Furthermore, in accordance with some preferred embodiments of the present invention, the airflow indicator is located adjacent one of the adapters.

Furthermore, in accordance with some preferred embodiments of the present invention, the air-flow indicator is located adjacent the adapter which is to be connected to the deflated tire.

Furthermore, in accordance with some preferred embodiments of the present invention, the device comprising a non-return valve.

Furthermore, in accordance with some preferred embodiments of the present invention, the device comprising a valve preventing the flow of air

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates an air inflation device (21) comprising an air-flow indicator which comprises an orb and connected to an inflated vehicle tire and a deflated vehicle tire in accordance with a preferred embodiment of the present invention.

FIG. 2a illustrates an air-flow indicator integrated within a tube and comprising a vane in accordance with a preferred embodiment of the present invention; FIG. 2b illustrates an air-flow indicator integrated within a tube and comprising a whistle in accordance with a preferred embodiment of the present invention.

FIG. 3 illustrates a tire inflation device connected to an inflated tire vehicle and to a deflated tire vehicle comprising a controlling air-flow indicator (45) in accordance with another preferred embodiment of the present invention.

FIG. 4a illustrates a tire inflation device as shown in FIG. 3, further comprising a stop valve, the device connected to an inflated vehicle tire, in accordance with another preferred embodiment of the present invention; FIG. 4b illustrates a tire inflation device as shown in FIG. 3, further comprising graphical indications, the device connected to a deflated vehicle tire, in accordance with another preferred embodiment of the present invention.

### DETAILED DESCRIPTION OF PREFERRED EMBODIMENTS

The principles and operation of a device for tire inflation according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing.

Unless otherwise defined, all technical and scientific terms used herein have the same meaning as commonly understood by one of ordinary skill in the art to which this invention belongs. The materials, methods, and examples provided herein are illustrative only and are not intended to be limiting.

As used herein the specification and in the claims section that follows, the term ‘inflation’ and the like in the context of vehicles tires refer to substantially filling air into a vehicle tire in a manner that increases the air pressure to a volume designated for maintaining sufficient air pressure to enable safe use of the tire. This pressure can also be within an inner tube between the tire and wheel rim, or in the space between the tire and rim in tires with no inner tube.

It is an objective of the present invention to provide a tire inflation device comprising an air-flow indicator which indicates the user, clearly and in an obvious way, of the existence of air-flow, and may also indicate id air flows in the right direction (meaning from the inflated tire to the deflated one) or not and by that indicating the user to take action in order to prevent air loss. Furthermore, such an obvious indication simplifies the use of the tire inflation device and prevents wrong usage.

In addition, it is an objective of the present invention to provide a tire inflation device comprising a simple non-return valve mechanism that prevents air loss and serves simultaneously as a visual air-flow indicator, thus providing an economical, very easy to use, multi-purpose, highly efficient and yet simple air inflation device.

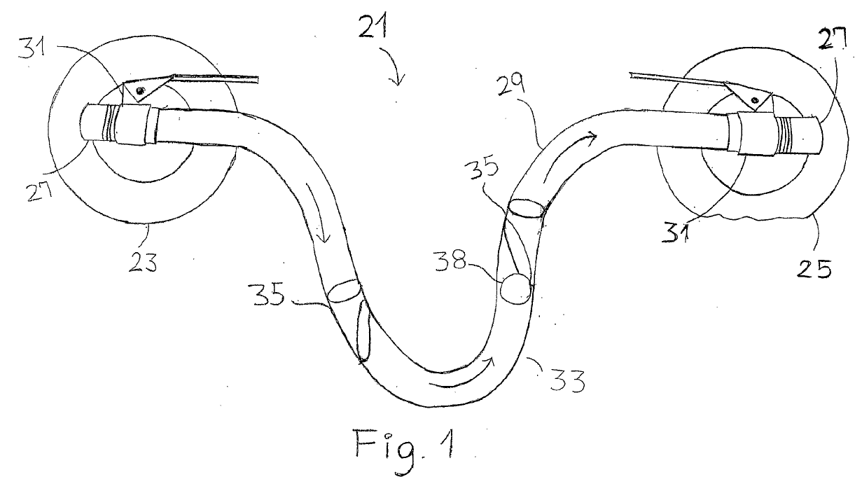

Referring now to the drawings, FIG. 1 is an illustration of a preferred embodiment of a device for inflating a vehicle's tire (21) from a source of air pressure in another of the inflated vehicle's tires (23). The inflated tire (23) is with air pressure that is suitable for driving safely according to the conditions of the road and the weight of the vehicle. The deflated tire (25) is with no sufficient air pressure to enable a safe drive as such.

The illustration shows a tire valve (27) through which air can be filled to inflate the deflated tire (25). Moreover, the inflated tire (23) is also equipped with a tire valve (27).

The device (21) further comprises a tube (29) designed in dimensions suitable for its purpose and composed of materials suitable for functioning safely according to the air pressures it may contain. A tire adapter (31) is disposed at each end of the tube (29) enabling fast connection to the tires valves (27) and fast disconnection from the tires valves (27). The adapter (31) is connected to the tube in a manner that ensures duration of the air pressures that the device (21) may contain. The tire adapter preferably does not allow any air loss in the course of air inflation. The tire adapter can be of any kind of adapters or connectors used in air filling devices or of the kind found in gas stations. In this specific embodiment the adapter used is a European style clip-on air chuck.

The tire inflation device (21) further comprises an air-flow indicator. This specific embodiment comprises an orbicular air-flow indicator (33), which provides a visual indication and is located within the tube.

In case of a visual air-flow indicator located within the tube, the tube should be transparent in at least that portion of the tube which contains the air-flow indicator and in a manner that the air-flow indicator can be clearly seen and noticed by the user of the tire inflation device (21). By transparent is meant, in the context of the present invention, full or partial transparency by allowing some or all lengths of wave in visual range to be seen.

The air-flow indicator is aimed at indicating the user in a very obvious and simple manner of air-flow existence, and is some cases of air-flow direction in the tire inflation device while the air is flowing from one tire to the other. The air-flow indicator provides us with the advantage of knowing when and if the air is flowing through and when it has come to a halt. Furthermore, it may provide us with the advantage of knowing to which direction the air flows within the tube, and especially whether air flows into the deflated tire or out of the deflated tire, while in the last case, undesired air loss might occur. Furthermore, the air-flow indicator may indicate the user of a proper or improper use of the air inflation device. Thus, the air-flow indicator will especially be beneficial to the users who lack a technical sense and will provide them with a sense of relief.

The indication may be visual, acoustic or be embodied in any other way, which fit the hereinabove detailed requirements. When the air-flow indicator is visual, it is preferably located adjacent one of the tire adapters (31) so it would be easier and more convenient for the user to watch and follow the indicator.

The illustration shows the tire inflation device (21) connected to the inflated (23) and deflated (25) tires. Each tire adapter (31) at each end of the tube (29) is connected to each tire valve (27). Due to that connection, air flows from the space within the inflated tire (23) to the space within the deflated tire (25). This process can continue until equalization of pressure in both tires or until it is stopped, for example by disconnecting the device from one of the tire valves.

The tire adapters (31) can be composed of any suitable material, such as rubber, metal, plastic, and composite materials. It can be of any common kind such as clip on-air chuck, thread air chuck or lock on-air chuck. The tube can be composed of any sealed material, such as rubber, plastic or metal. The tube is preferably, at least partially, made of a flexible material such as rubber.

The orbicular air-flow indicator (33) comprises two limiters (35) and an orb (38). The orb and the limiters are located within the tube. The orb is located between the two limiters and in at least a portion of the tube that is transparent. The limiters are preferably located in at least a portion of the tube that is transparent as well. The limiters (35) are aimed at limiting the motion of the orb within a predetermined distance but allowing passage of air simultaneously. Different shapes and designs of limiters, or different limiters mechanisms may achieve this aim.

The orbicular air-flow indicator (33) allows the user to identify the air flow existence and direction as when an air pressure is formed in the tube, it causes the orb to stick to one limiter or to the other, according to the direction of the air-flow. In case there is no air pressure in the tube, then the orb would move freely inside the tube and between the limiters.

The orb is preferably made of a solid material such as rubber, plastic or metal. The surface of the orb is preferably at least partially smooth and in a way that enables a free movement of the orb within the tube (29). The dimensions of the orb should be as such that would allow the orb to move freely within the tube and not to prevent the passage of air within the tube. The weight of the orb should be taken into account as the air flow designated to flow in the tube should be able to move and further more, to push, the orb from one limiter to the other and along a visible and noticeable distance.

The limiters (35) are fixed within the tube in a manner that would not enable their dislocation, mainly not by the air pressure, which is to be formed within the tube. The limiters are located within a reasonable distance from each other. By ‘reasonable distance’ it is meant a minimum distance, which would allow a visible and noticeable movement of the orb from one limiter to the other.

In this specific embodiment, each limiter comprises a tubular member having internal passage smaller than the dimensions of the orb (38) presenting an inclined rim towards the orb, causing the orb to be held sideways against an inside wall of the tube when air flows in the direction of each limiter accordingly. Hence, the orb would be pushed until halted to one limiter or the other by the air pressure formed by the air-flow within the tube indicating by that the specific direction of that air-flow.

The orbicular air-flow indicator (33) may comprise a housing transparent in at least a portion of it, which would house the limiters (35) and the orb (38).

The air-flow indicator is preferably located adjacent one of the adapters (31) and the device (21) is preferably connected in a way that the adapter, which is mostly adjacent the air-flow indicator is the one which is to be connected to the deflated tire (25). The aforesaid assuming that the indication of air flowing in or out of the deflated tire (25) is the most important one and in comparison with the indication of air flowing in or out of the inflated tire (23). In case the indication of air flowing in or out of the inflated tire is the more important one, the device should be assembled and used inversely and accordingly. Thus, the indication is more accurate and instantaneous. Of course, any other position of the air-flow indicator in a device according to the present invention and in relation to the different connections by each adapter (31) (to the deflated (25) or the inflated tire (23)) might do.

At least one of the limiters (35) may be integrated with one of the adapters (31).

It should be noted that the inflated tire (23) from which the air is taken to inflate the deflated tire (25) may be one of the other vehicle's tires or a spare tire or a tire of another vehicle.

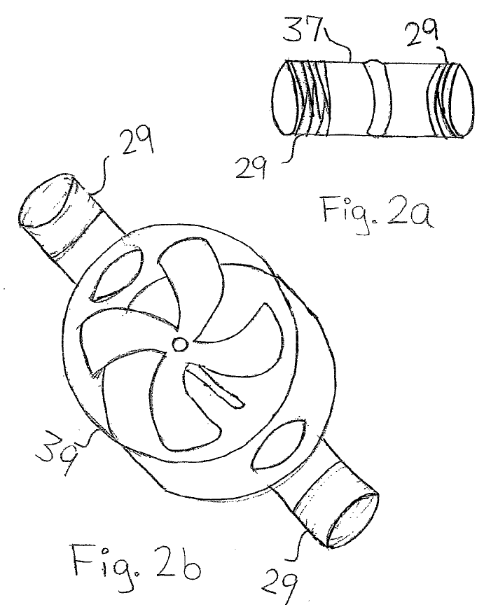

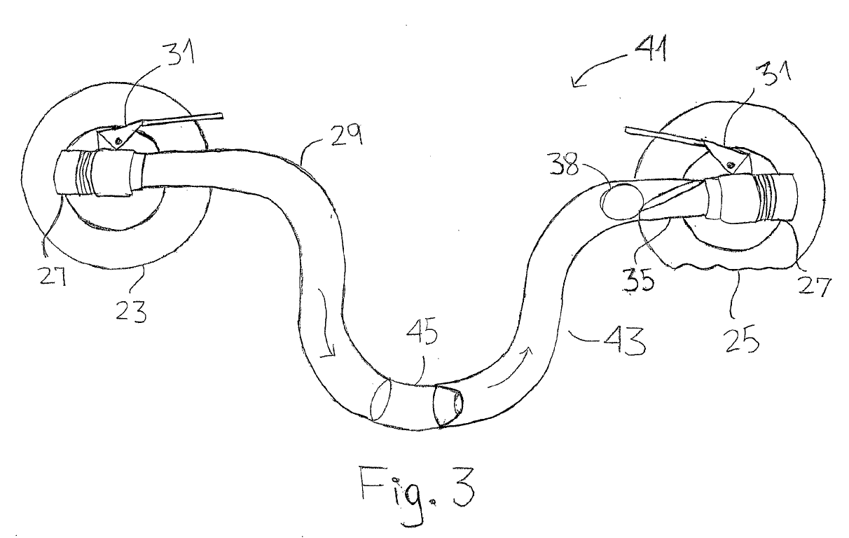

FIG. 2a illustrates an air-flow indicator comprising a whistle (37) integrated within the tube (29). The whistle allows the user to identify existence of air-flow by its whistling sound. When the device (21) is connected to both tires, than whistling sound indicates that there is air flowing from one tire to the other, and when the whistling sound is stopped, it indicated the user that the inflation operation is over and he can remove the tire inflation device (21). If the device is connected to only one of the tires, then a whistling sound serves as an alarm for air loss from that tire.

FIG. 2b illustrates an air-flow indicator comprising a vane (39) integrated within the tube (29). The vane allows the user to identify an air-flow existence within the tube by the turning of the propeller that is caused by the air pressure, and when stopped indicates of a lack of air-flow. If in that time the device is connected to both tires, then the stop of the vane rotation means the inflation operation is over, the tires air pressure is balanced and the device may be disconnected. According to the direction of the rotation of the vane, one can see in which direction the air flows in the inflation device (21). The vane is preferably fixed within the tube in a way that does not allow any displacement of the vane within the tube.

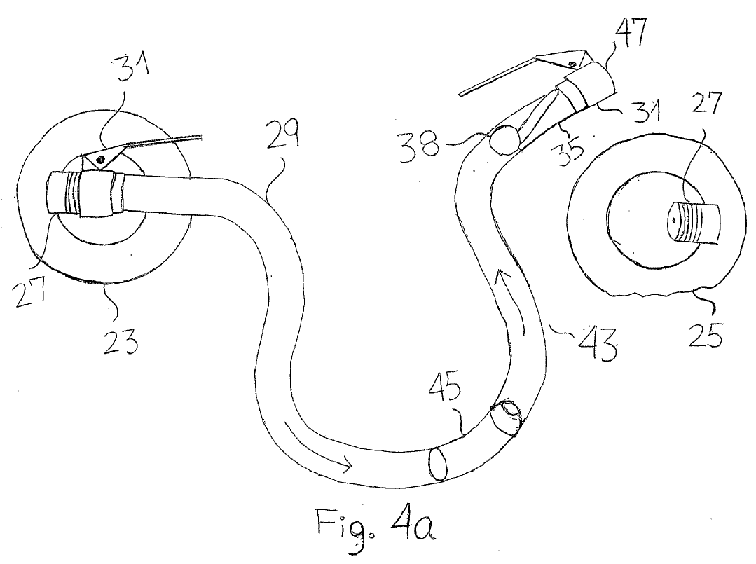

FIG. 3 illustrates an illustration of another embodiment of a tire inflation device (41) comprising an orbicular air-flow controlling indicator (43) according to the present invention connected to the deflated tire (25) and the inflated tire (23) at each end.

This embodiment of the present invention utilizes the orbicular air-flow indicator (33) as an air-flow controlling system by further comprising a non-return valve, that is to improve the prevention of loss of air during the tire inflation operation. For further clarification, it should be said that in the context of the present invention, a non-return valve is a valve that is aimed at allowing flow of air in only one direction.

In this specific embodiment, the non-return valve is integrated with one of the limiters (35) and by that forming an air-flow control limiter (45) that limits the motion of the orb (38) and enables air-flow in only one direction.

In this specific embodiment, the air-flow control limiter (45) comprises a hollow tubular member with a passage having an opening that is smaller than the dimensions of the orb (38), whereby when the orb is pressed against the hollow tubular member the orb blocks the opening preventing air from flowing through the tube.

In this specific embodiment, the air-flow control limiter (45) is located between the orb and the inflated tire (23), thus not allowing air to flow out of the deflated tire (25) while connected to it. In addition, in this specific embodiment, the limiter (35) is integrated with the adapter (31).

Any embodiment according to the present invention may comprise a non-return valve in order to prevent air flowing in an undesired direction and mainly such as air flowing out of the deflated tire (25). The non-return valve should be located within the tube according to the preferred air-flow direction.

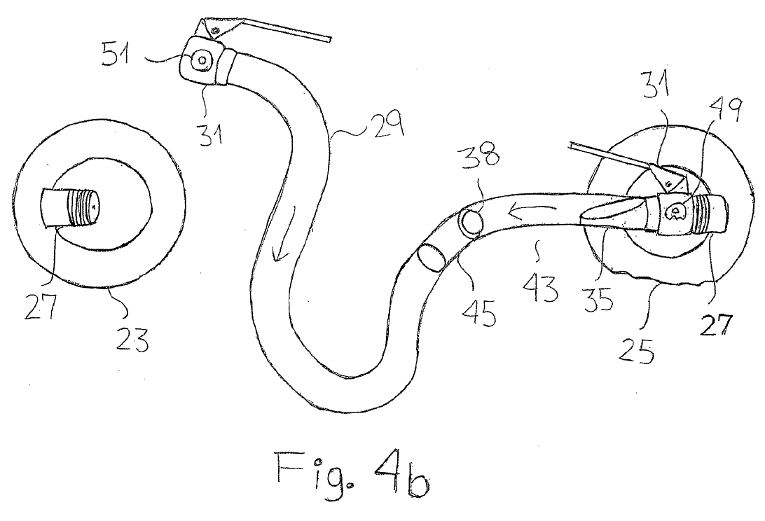

FIG. 4a illustrates the tire inflation device shown in FIG. 3 further comprising a stop valve (47) and connected to the inflated tire (23). By stop valve is meant in the context of the present invention a valve that serves to prevent air from flowing to the external environment when the device is disconnected from one of the tire valves (27).

The need for a stop valve arises when the device is connected to only one tire and in order to prevent air loss from that tire. Obviously, that prevention will take place if the stop valve is integrated with the tire adapter (31), which is disconnected.

In this specific embodiment there is a need for only one stop valve, as it comprises a non-return valve, which prevents air loss from the deflated tire in case the device is connected or disconnected from the inflated one (23). Therefore, in this specific embodiment the stop valve (47) should be integrated with the adapter that is to be connected to the deflated tire and as shown in the figure. Hence, air loss is prevented in any incident that might occur during a reasonable use of the tire inflation device, including air loss from the inflated tire (23), that might happen when connecting the inflated tire first or disconnecting the deflated tire first, as shown in the present figure.

FIG. 4b illustrates the tire inflation device shown in FIG. 3, further comprising graphical images, and connected to the deflated tire (23). As said hereinabove, the non-return valve prevents any air loss in case only the deflated tire (25) is connected. This may occur when connecting the deflated tire (25) first or disconnecting the inflated tire (23) first. On both cases, the air-flow control limiter (45) prevents from air to flow out of the inflated tire (25).

In the specific embodiment shown in the figure, the adapter (31), which is most adjacent to the orbicular air-flow controlling indicator (43), is the one designated to connect to the deflated tire, that is according to the limiter (35) and the air-flow control limiter (45) directions and position within the tube (29). In order to further clarify the proper use of the device, the adapter (31) designated to be connected to the deflated tire (25), as detailed hereinabove, comprises a graphical image of a deflated tire (49), and the other adapter (31), therefore designated to connect to the inflated tire (23), comprises a graphical image of an inflated tire (51).

Any embodiment of the present invention may comprise at least one stop valve integrated with one of the adapters, for the prevention of air loss in case only one tire is connected to a tire inflation device according to the present invention.

Any tire inflation device according to the present invention may comprise indications on proper connection of the device and such as tags stuck or graphical images imprinted on the tube or on the adapters or on any other visible and noticeable component of a device according to the present invention. The device may also be provided with night glowing indications for enabling a safe and easy usage at nighttime as well.

A tire inflation device according to the present invention may also comprise a night glowing air-flow indicator for the sake of enabling an easy and more comfortable usage of the device during nighttime.

Any embodiment of the present invention may also be equipped with additional components, such as spigots, pressure gauges and flow gauges.

The components of a tire inflation device according to the present invention, such as tube (29), tire adapters (31), and the different limiters and valves can be composed of any suitable material, such as rubber, metal, plastic, and composite materials.

The spare tire is sometimes located within the vehicle or in a manner that makes access to the tire valve (27) difficult, for example in a private vehicle, in which the spare tire is stored in the trunk and said trunk may contain obstructive objects. Therefore an extending device can be added to a device for tire inflation according to the present invention, and the extending device can be attached to the valve of the spare tire, for as long as this tire is not assembled to the vehicle for travel purposes. The extending device can include a tube, on one end of which an adapter suitable for connection to the tire valve is disposed, and on the other end of which a tire valve is disposed.

A tire inflation device according to the present invention can be stored in a folded mode inside of the vehicle during everyday parking and motion. It is removed from storage for use and is folded and returned to storage after use is completed.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Although the present invention was discussed with reference to tire inflation it is understood that the device of the present invention may be engaged to a tire and used for inflating other inflatable objects.

Although the present invention was discussed with reference to an inflated tire as the air source for inflating a deflated tire it is understood that the device of the present invention may be engaged to other air sources with higher air pressure than the air pressure of the deflated tire.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A device for inflating a deflated vehicle tire comprising:
a tube;
a first adapter and a second adapter disposed at each end of the tube, wherein the adapters are suitable for connecting to a valve of a vehicle tire, facilitating air flow; and
an air-flow indicator which indicates existence of air-flow within the tube.

2. The device of claim 1, wherein the air-flow indicator comprises acoustic air-flow indicator.

3. The device of claim 2, wherein the acoustic air-flow indicator comprises a whistle.

4. The device of claim 1, wherein the air-flow indicator comprises a visual air-flow indicator.

5. The device of claim 4, wherein at least a portion of the tube is transparent.

6. The device of claim 5, wherein the visual air-flow indicator comprises a vane located within said at least portion of the tube that is transparent.

7. The device of claim 5, wherein the visual air-flow indicator comprises an orb located within said at least a portion of the tube that is transparent, the orb dimensions allowing the orb to move freely inside the transparent portion of the tube, and a first and second limiters located on either sides of the orb, limiting the motion of the orb within a predetermined distance within the tube and allowing passage of air.

8. The device of claim 7, wherein the orb is made of a solid material.

9. The device of claim 7, wherein at least one of the limiters comprises a tubular member having internal passage smaller than the dimensions of the orb presenting an inclined rim towards the orb, causing the orb to be held sideways against an inside wall of the tube when air flows in the direction of said at least one limiter.

10. The device of claim 7, wherein at least one of the adapters is integrated with one of the limiters.

11. The device of claim 7, further comprising a non-return valve.

12. The device of claim 11, wherein the non-return valve is integrated with the air-flow indicator.

13. The device of claim 12, wherein the non-return valve comprises a hollow tubular member with a passage having an opening that is smaller than the dimensions of the orb, whereby when the orb is pressed against the hollow tubular member the orb blocks the opening preventing air from flowing through the tube.

14. The device of claim 12, wherein the non-return valve is integrated with one of the limiters.

15. The device of claim 1, provided with at least one indication on proper connection of the device.

16. The device of claim 1, wherein the airflow indicator is located adjacent one of the adapters.

17. The device of claim 16 wherein the air-flow indicator is located adjacent the adapter which is to be connected to the deflated tire.

18. The device of claim 1, further comprising a non-return valve.

19. The device of claim 1, further comprising a valve preventing the flow of air within the tube when either of the adapters is not connected to a tire.

20. The device of claim 1 wherein the tube is flexible.
